(19) United States
(12) Patent Application Publication
(10) Pub. No.: US 2025/0005034 A1
(43) Pub. Date: Jan. 2, 2025

(54) Cloud Platform Based Management of Data Centers

(71) Applicant: Google LLC, Mountain View, CA (US)

(72) Inventors: Ramasimha Rangaraju, Bengaluru (IN); Johnson Plathottam Jose, Bengaluru (IN); Srivats Ramaswami, Saratoga, CA (US); Sandesh Dayanand Raikar, Menlo Park, CA (US)

(21) Appl. No.: 18/215,991

(22) Filed: Jun. 29, 2023

(51) Int. Cl. G06F 16/25

(52) U.S. Cl. CPC G06F 16/258

(57) ABSTRACT

Aspects of the disclosure are directed to a cloud based data center management platform. The data center management platform collects telemetry data associated with various data centers from heterogeneous data sources and transforms the heterogeneous telemetry data into a homogeneous data set. The data center management platform generates metrics from the homogeneous data set for monitoring the various data centers. The data center management platform can trigger an alert from monitoring the metrics and can also predict potential future alerts from the metrics.

### BACKGROUND

Data centers are facilities that house information technology operations and equipment for an organization. Data centers can require continuous monitoring of their various power and building equipment, such as generators, chillers, busbars, etc. To continuously monitor the various power and building equipment, each data center can generate telemetry data. However, the telemetry data for each data center can be based on individual equipment manufacturer type and/or individual configurations, resulting in heterogeneous telemetry data. Heterogeneous telemetry data can result in difficulty managing the data centers as a whole, including monitoring current and historical trends for comparison and/or prediction.

### BRIEF SUMMARY

Aspects of the disclosure are directed to a cloud based data center management platform. The data center management platform collects telemetry data associated with various data centers from heterogeneous data sources and transforms the heterogeneous telemetry data into a homogeneous data set. The data center management platform generates metrics from the homogeneous data set for monitoring the various data centers. The data center management platform can trigger an alert from monitoring the metrics and can also predict potential future alerts from the metrics.

An aspect of the disclosure provides for a method for managing various data centers, including: collecting, by one or more processors, heterogeneous telemetry data from a plurality of data centers; transforming, by the one or more processors, the heterogenous telemetry data into homogenized data using a mapping; generating, by the one or more processors, a plurality of metrics associated with the homogenized data; and monitoring, by the one or more processors, the plurality of data centers using the plurality of metrics.

In an example, the method further includes displaying, by the one or more processors, the plurality of metrics in real-time via a user interface.

In another example, the heterogenous telemetry data is collected from a plurality of data sources associated with the plurality of data centers. In yet another example, the heterogenous telemetry data includes telemetry data in a plurality of data formats. In yet another example, the homogenized data includes telemetry data converted to a data object format with predetermined parameters for monitoring.

In yet another example, the method further includes storing, by the one or more processors, the homogenized data in logs segregated by data center of the plurality of data centers. In yet another example, the method further includes determining, by the one or more processors, that the homogenized data of a log of a data center is being received within a threshold frequency range.

In yet another example, the method further includes comparing the plurality of metrics to one or more configurable thresholds. In yet another example, the method further includes: determining, by the one or more processors, at least one metric of the plurality of metrics has exceeded a threshold; and providing, by the one or more processors, a notification to a client device in response to the at least one metric exceeding the threshold. In yet another example, the method further includes: determining, by the one or more processors, at least one metric of the plurality of metrics has exceeded a threshold; and providing, by the one or more processors, instructions to a computing device associated with a data center of the plurality of data centers to automatically perform a corrective measure in response to the at least one metric exceeding the threshold.

In yet another example, the method further includes generating, by the one or more processors, a prediction associated with a data center based on historical data of the plurality of metrics.

Another aspect of the disclosure provides for a system including: one or more processors; and one or more storage devices coupled to the one or more processors and storing instructions that, when executed by the one or more processors, cause the one or more processors to perform operations for managing various data centers, the operations including: collecting heterogeneous telemetry data from a plurality of data centers; transforming the heterogenous telemetry data into homogenized data using a mapping; generating a plurality of metrics associated with the homogenized data; and monitoring the plurality of data centers using the plurality of metrics.

In an example, the operations further comprise displaying the plurality of metrics in real-time via a user interface.

In another example, the heterogenous telemetry data includes telemetry data in a plurality of data formats. In yet another example, the homogenized data includes telemetry data converted to a data object format with predetermined parameters for monitoring.

In yet another example, the operations further include storing the homogenized data in logs segregated by data center of the plurality of data centers. In yet another example, the operations further include determining that the homogenized data of a log of a data center is being received within a threshold frequency range.

In yet another example, the operations further include: comparing the plurality of metrics to one or more configurable thresholds; determining at least one metric of the plurality of metrics has exceeded a threshold; and providing a notification to a client device in response to the at least one metric exceeding the threshold. In yet another example, the operations further include: comparing the plurality of metrics to one or more configurable thresholds; determining at least one metric of the plurality of metrics has exceeded a threshold; and providing instructions to a computing device associated with a data center of the plurality of data centers to automatically perform a corrective measure in response to the at least one metric exceeding the threshold.

Yet another aspect of the disclosure provides for a non-transitory computer readable medium for storing instructions that, when executed by one or more processors, cause the one or more processors to perform operations for managing various data centers, the operations including: collecting heterogeneous telemetry data from a plurality of data centers; transforming the heterogenous telemetry data into homogenized data using a mapping; generating a plurality of metrics associated with the homogenized data; and monitoring the plurality of data centers using the plurality of metrics.

### BRIEF DESCRIPTION OF THE DRAWINGS

FIG. 1 depicts a block diagram of an example data center management system according to aspects of the disclosure.

FIG. 2 depicts a block diagram further detailing an example data center management system according to aspects of the disclosure.

FIG. 3 depicts a block diagram of an example environment for implementing a data center management system according to aspects of the disclosure.

FIG. 4 depicts a flow diagram of an example process for managing various data centers according to aspects of the disclosure.

FIG. 5 depicts an example table showing various log-based metrics that can be generated according to aspects of the disclosure.

FIG. 6 depicts an example dashboard showing real-time displays of various metrics according to aspects of the disclosure.

### DETAILED DESCRIPTION

The technology relates generally to managing various data centers through a cloud based data center management platform. The data center management platform collects telemetry data from heterogeneous data sources and transforms the telemetry data into a homogeneous data set. The data center management platform generates metrics from the homogeneous data set for monitoring the various data centers. The data center management platform can trigger an alert from monitoring the metrics based on configurable conditions, such as a metric exceeding a threshold or the absence of a metric. The data center management platform can also predict potential future alerts from the metrics.

Data centers are facilities that house information technology operations and equipment for an organization. The data centers can include various power and building equipment, such as generators, chillers, busbars, etc., which require continuous monitoring. The data centers generate heterogeneous telemetry data based on their individual equipment manufacturer type and configurations, requiring individual monitoring. The data center management platform allows for continuously monitoring the data centers in a centralized manner from homogenized telemetry data, as well as retaining historical trends for failure prediction and automatic correction. Monitoring the homogenized data allows for simultaneous comparison of the functioning of different data centers and establishing patterns between the homogenized telemetry data over a timeline. Performance of equipment from different manufacturers under similar environmental conditions can also be assessed with this homogenized telemetry data. The data center management platform includes an integration engine, an evaluation engine, and a response engine.

The integration engine is configured to collect telemetry data from various data sources associated with data centers. The various sources can include data provided by servers providing representational state transfer (REST) application programming interface (API), message queue telemetry transport (MQTT) publishers or brokers, or Kafka servers, as examples. These sources can transmit data in formats like javascript object notation (JSON), text based, etc. The integration engine can include a transport layer for each data source type to collect the telemetry data as a data log, with one log per data center. The telemetry data can be heterogeneous, including various formats of data. This data is sent by equipment from various manufacturers which can have various naming conventions and associated tags. These tags need to be standardized in considering the overall layout and structure of the data center.

The integration engine is further configured to transform the heterogenous telemetry data into a homogenized format. For example, the telemetry data can be transformed into data objects, e.g., JSON objects, having a set of pre-defined attributes for monitoring. The pre-defined attributes cover parameters like voltage, power, current, temperature, pressure, etc., which need to be measured to determine the datacenter health. The integration engine can transform the heterogeneous telemetry data using a map of key-value pairs. The map is generated using a pre-defined interface agreement with the data center and mapping the runtime data points to the pre-defined data points. For example, when a data center sends a JSON object with all the attributes as JSON elements, the integration engine parses the JSON object in its java code, and uses a map created based on the interface agreement provided by the datacenter and transforms the data. For each data center, the mechanism can convert specific data to a homogenized format. The integration engine can store the homogenized data in logs. The logs can be segregated by data center.

The evaluation engine is configured to monitor the homogenized data. For each log, the evaluation engine can compare the homogenized data of that log to data received by that data center to determine that the homogenized data of that log matches a frequency of data or is within a threshold frequency range of data. This threshold frequency is used to configure alerts to various stakeholders and engineers who would need to perform actions on the data center equipment to prevent and mitigate risks.

The evaluation engine is further configured to generate various metrics for monitoring the homogenized data. The metrics can be log-based metrics for each log of homogenized data representing each data center. An example metric is to measure the temperature across all the data centers simultaneously and display them as time series data so that co-relations in the temperature to factors like month of the year, usage loads, or other external factors can be established. The evaluation engine can generate the metrics by aggregating similar data points together to allow for simultaneously comparing telemetry data from the various data centers and viewing their changes over a timeline. Based on pre-defined attributes, data coming from different data centers but which represent the same functional unit of measurement are displayed together. The metrics can be viewed via a dashboard or user interface that can display the metrics over time to provide an operational view on how the data centers are functioning.

The response engine is configured to generate and provide instructions based on the metrics. The instructions can include an alert, notification, and/or corrective measures regarding a metric of a data center. The response engine can output instructions based on comparing the metrics to configurable threshold values or absence of data. For example, if a threshold value for a metric is exceeded, the response engine can provide a notification to a user device via configurable channels, such as email or SMS, to mitigate risk and/or apply corrective measures. For instance, the response engine can provide an alert if a temperature of a data center exceeds a threshold.

The response engine is further configured to predict potential issues in data centers based on historical data of the metrics. The response engine can output instructions based on a prediction to mitigate and/or prevent the potential issues. The response engine can include one or more machine learning models to predict the issues using the historical data. For instance, the response engine can determine from historical data that a temperature of a data center may exceed a threshold during a particular time of year. The response engine can provide an alert before the data center temperature exceeds the threshold to prevent the data center from exceeding the threshold.

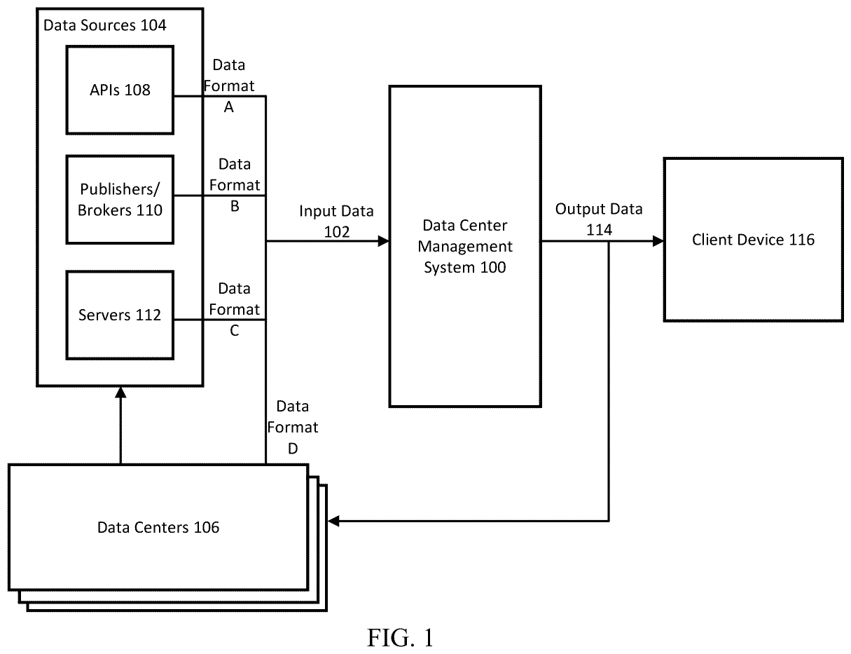

FIG. 1 depicts a block diagram of an example data center management system 100 for managing various data centers through a cloud based platform. The data center management system 100 can be configured to receive input data 102 via an interface. The data center management system 100 can receive the input data 102 from one or more data sources 104 associated with one or more data centers 106 or directly from the one or more data centers 106. The one or more data sources 104 can include application programming interfaces (APIs) 108, such as representational state transfer (REST) APIs. The one or more data sources 104 can further include data publishers or brokers 110, such as message queue telemetry transport (MQTT) publishers or brokers. The one or more data sources 104 can also include data servers 112, such as Kafka servers. The data center management system 100 can receive the input data 102 as part of a call to an API, through a storage medium like remote storage connected to one or more computing devices over a network, and/or through a user interface on a computing device coupled to the data center management system 100.

The input data 102 can include heterogeneous telemetry data associated with the one or more data centers 106 and/or data sources 104 associated with the data centers 106. The heterogenous telemetry data can include data associated with determining a fitness or health of each of the one or more data centers 106, such as temperature, voltage, power, power factor, fault, generator status, humidity, chiller run status, supply air temperature, return air temperature, current, and/or pressure of various power and building equipment at various levels like bus, data hall, and/or zone for the data centers 106. Heterogeneous telemetry data can refer to data that is received from various sources having various data formats, depicted in FIG. 1 as data format A-D, though any number of data formats can be received. For example, the data centers 106 can each generate data in a format based on their equipment manufacturer type or configuration, which can have various naming conventions and associated tags. The data formats can include javascript object notation (JSON), comma separated value (CSV), protocol buffers, and/or text based format, as examples. The data centers 106 can provide the data in its original format to the data sources 104 or directly to the data center management system 100. By receiving the input data 102, the data center management system 100 can receive data in various formats for determining a fitness or health of various data centers 106.

From the input data 102, the data center management system 100 can be configured to output one or more results related to managing the various data centers 106, generated as output data 114. For example, the data center management system 100 can send the output data 114 for display on a client or user device 116 to provide an operational view of how the data centers 106 are functioning. As another example, the data center management system 100 can provide the output data 114 as a set of computer readable instructions, such as one or more computer programs for managing the data centers 106 or automatically correcting faults found in one or more of the data centers 106. The data center management system 100 can also forward the output data 114 to one or more other devices configured for translating the output data 114 into an executable program written in a computer programming language. As yet another example, the data center management system 100 can send the output data 114 to a storage device for storage and later retrieval, such as for determining trends in the functioning of the data centers 106.

The computer programs can be written in any type of programming language, and according to any programming paradigm, e.g., declarative, procedural, assembly, object-oriented, data-oriented, functional, or imperative. The computer programs can be written to perform one or more different functions and to operate within a computing environment, e.g., on a physical device, virtual machine, or across multiple devices. The computer programs can also implement functionality described herein, for example, as performed by a system, engine, module, or model.

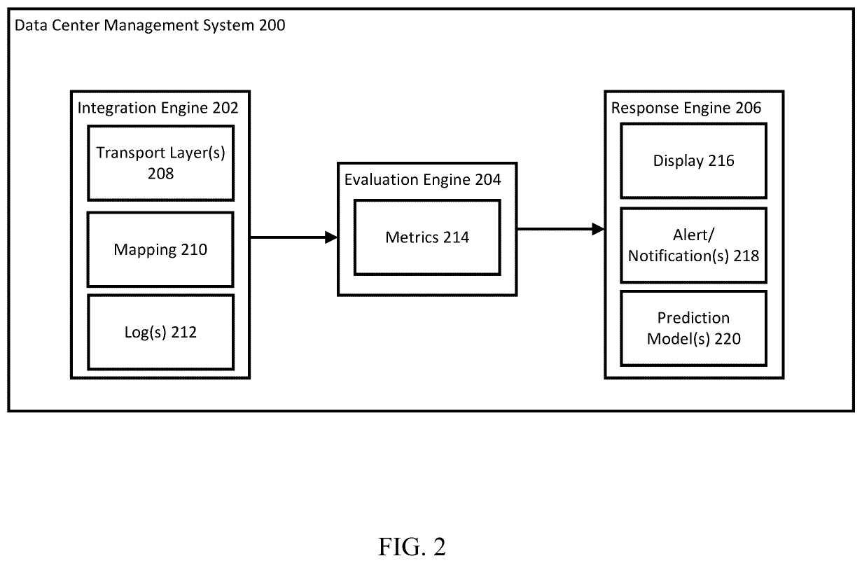

FIG. 2 depicts a block diagram of a data center management system 200. The data center management system 200 can correspond to the data center management system 100 as depicted in FIG. 1. The data center management system 100 can include an integration engine 202, an evaluation engine 204, and a response engine 206. The integration engine 202, evaluation engine 204, and response engine 206 can be implemented as one or more computer programs, specially configured electronic circuitry, or any combination thereof.

The integration engine 202 can be configured to receive the heterogeneous telemetry data from the various data sources 104 and/or directly from the data centers 106. As described above, the heterogeneous telemetry data can refer to data that is received from various sources having various data formats. The integration engine 202 can include a transport layer 208 for each data source type. For example, the integration engine 202 can include a first transport 208 layer for data received via APIs 108, a second transport layer 208 for data received via publishers or brokers 110, a third transport layer 208 for data received via servers 112, and/or a fourth transport layer 28 for data received directly from the data centers 106. Each of these transport layers 208 can operate independently and perform data ingestion at different, independent intervals.

The integration engine 202 can be further configured to transform the heterogeneous telemetry data into homogenized data, such as into a homogenized format. For example, the integration engine 202 can transform the heterogeneous telemetry data into data objects, such as JSON objects. The data objects can include a plurality of parameters for monitoring the data centers 106, such as voltage, power, current, temperature, and/or pressure. The integration engine 202 can be configured to parse the heterogeneous telemetry data and use a mapping 210 of predetermined key-value pairs to transform the heterogeneous telemetry data. The integration engine 202 can generate the mapping 210 by associating predetermined data points in various data formats with a homogenized data format based on interfacing with the data sources 104 and/or data centers 106.

The integration engine 202 can also be configured to store the homogenized data as data logs 212, with one log per data center 106. For example, the logs 212 can be segregated by data center. Each log 212 can include one or more parameters for assessing the fitness or health of the data center.

The evaluation engine 204 can be configured to monitor the homogenized data. The evaluation engine 204 can be configured to compare the homogenized data of a log 212 representing a data center to data received by that data center to determine whether the homogenized data of that log 212 matches a frequency of data or is within a threshold frequency range for the data. The evaluation engine 204 can use the threshold frequency range to ensure data for each data center is being received by the data center management system 100. If the evaluation engine 204 determines the homogenized data does not match the frequency of data or is outside the threshold frequency range, the evaluation engine 204 can provide instructions to the response engine 206 to generate an alert or perform an automatic correction to prevent and/or mitigate risks of data center faults.

The evaluation engine 204 can be further configured to generate one or more metrics 214 to monitor the homogenized data for each data center. The evaluation engine 204 can generate the metrics 214 based on the one or more parameters included in each log 212 for assessing the fitness or health of the data center. For example, the evaluation engine 204 can generate a metric 214 for temperature to monitor temperature across the data centers 106 simultaneously. The evaluation engine 204 can monitor the temperature as time series data to establish correlations in temperature to other factors, such as months of the year, usage loads, and/or other external factors. The evaluation engine 204 can aggregate similar data points together to generate the one or more metrics 214 and simultaneously compare the heterogeneous telemetry data from the data centers 106 over a timeline. For example, data received from different data centers 106, but which represent the same functional unit of measurement, e.g., temperature, power, etc., can be aggregated based on the one or more parameters included in each log 212. The evaluation engine 204 can simultaneously compare each metric 214 to configurable threshold values or an absence of data being received to determine whether the response engine 206 should provide an alert or corrective instructions.

The response engine 206 can be configured to generate and output instructions based on the one or more metrics 214. For example, the response engine 206 can output instructions to display 216 data for monitoring the one or more metrics 214, such as on a client device 116. The instructions can include representing the same functional unit of measurement together in the display 216 for the various data centers 106. The instructions can include displaying the metrics 214 on a dashboard or user interface over time to provide an operational view for how the data centers 106 are functioning.

As another example, the response engine 206 can output instructions for providing an alert or notification 218 to a client device 116. For example, if a configurable threshold value for one or more of the metrics is exceeded, the response engine 206 can output instructions to the client device 116 for mitigating risk or applying a corrective measure to the data center 106 whose metric has been exceeded. The response engine 206 can output the instructions via configurable communication channels, such as email or short message service (SMS). For example, the response engine 206 can provide an alert 218 to the client device 116 if a temperature of a data center 106 exceeds a threshold.

The response engine 206 can also output instructions associated with predicting potential faults or issues in the data centers 106 based on historical data of the metrics 214. Predicting the potential faults or issues can mitigate and/or prevent the actual faults or issues. The response engine 206 can include one or more machine learning models or regression models 220 to predict the issues using the historical data. For example, the response engine 206 can determine from historical data that a temperature of a data center may exceed a threshold during a particular time of year. The response engine 206 can provide an alert 218 to the client device 116 before the data center temperature exceeds the threshold to prevent the data center 106 from exceeding the threshold. As another example, a regression model can predict power consumption in various data center units based on the server usages.

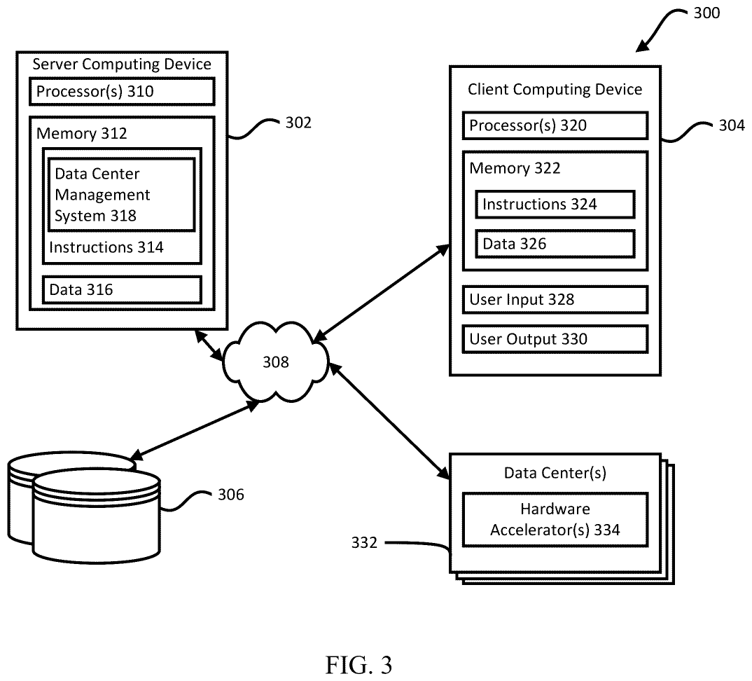

FIG. 3 depicts a block diagram of an example environment 300 for implementing a data center management system 318. The data center management system 318 can be implemented on one or more devices having one or more processors in one or more locations, such as in server computing device 302. Client computing device 304 and the server computing device 302 can be communicatively coupled to one or more storage devices 306 over a network 308. The storage devices 306 can be a combination of volatile and non-volatile memory and can be at the same or different physical locations than the computing devices 302, 304. For example, the storage devices 306 can include any type of non-transitory computer readable medium capable of storing information, such as a hard-drive, solid state drive, tape drive, optical storage, memory card, ROM, RAM, DVD, CD-ROM, write-capable, and read-only memories.

The server computing device 302 can include one or more processors 310 and memory 312. The memory 312 can store information accessible by the processors 310, including instructions 314 that can be executed by the processors 310. The memory 312 can also include data 316 that can be retrieved, manipulated, or stored by the processors 310. The memory 312 can be a type of transitory or non-transitory computer readable medium capable of storing information accessible by the processors 310, such as volatile and non-volatile memory. The processors 310 can include one or more central processing units (CPUs), graphic processing units (GPUs), field-programmable gate arrays (FPGAs), and/or application-specific integrated circuits (ASICs), such as tensor processing units (TPUs).

The instructions 314 can include one or more instructions that, when executed by the processors 310, cause the one or more processors to perform actions defined by the instructions 314. The instructions 314 can be stored in object code format for direct processing by the processors 310, or in other formats including interpretable scripts or collections of independent source code modules that are interpreted on demand or compiled in advance. The instructions 314 can include instructions for implementing a data center management system 318, which can correspond to the data center management system 100 of FIG. 1 or the data center management system 200 of FIG. 2. The data center management system 318 can be executed using the processors 310, and/or using other processors remotely located from the server computing device 302.

The data 316 can be retrieved, stored, or modified by the processors 310 in accordance with the instructions 314. The data 316 can be stored in computer registers, in a relational or non-relational database as a table having a plurality of different fields and records, or as JSON, YAML, proto, or XML documents. The data 316 can also be formatted in a computer-readable format such as, but not limited to, binary values, ASCII, or Unicode. Moreover, the data 316 can include information sufficient to identify relevant information, such as numbers, descriptive text, proprietary codes, pointers, references to data stored in other memories, including other network locations, or information that is used by a function to calculate relevant data.

The client computing device 304 can also be configured similarly to the server computing device 302, with one or more processors 320, memory 322, instructions 324, and data 326. The client computing device 304 can also include a user input 328 and a user output 330. The user input 328 can include any appropriate mechanism or technique for receiving input from a user, such as keyboard, mouse, mechanical actuators, soft actuators, touchscreens, microphones, and sensors.

The server computing device 302 can be configured to transmit data to the client computing device 304, and the client computing device 304 can be configured to display at least a portion of the received data on a display implemented as part of the user output 330. The user output 330 can also be used for displaying an interface between the client computing device 304 and the server computing device 302. The user output 330 can alternatively or additionally include one or more speakers, transducers or other audio outputs, a haptic interface or other tactile feedback that provides non-visual and non-audible information to the platform user of the client computing device 304.

Although FIG. 3 illustrates the processors 310, 320 and the memories 312, 322 as being within the computing devices 302, 304, components described herein can include multiple processors and memories that can operate in different physical locations and not within the same computing device. For example, some of the instructions 314, 324 and the data 316, 326 can be stored on a removable SD card and others within a read-only computer chip. Some or all of the instructions and data can be stored in a location physically remote from, yet still accessible by, the processors 310, 320. Similarly, the processors 310, 320 can include a collection of processors that can perform concurrent and/or sequential operation. The computing devices 302, 304 can each include one or more internal clocks providing timing information, which can be used for time measurement for operations and programs run by the computing devices 302, 304.

The server computing device 302 can be connected over the network 308 to one or more data centers 332 housing any number of hardware accelerators 334. The data centers 332 can be one of multiple data centers or other facilities in which various types of computing devices, such as hardware accelerators, are located. Computing resources housed in the data center 332 can be specified for deploying models related data center management as described herein.

The server computing device 302 can be configured to receive requests to process data from the client computing device 304 on computing resources in the data center 332. For example, the environment 300 can be part of a computing platform configured to provide a variety of services to users, through various user interfaces and/or application programming interfaces (APIs) exposing the platform services. The variety of services can include managing the data centers 332 or various other data centers. The data center management system 318 can receive heterogeneous telemetry data for the data centers, and in response, generate output data including instructions associated with monitoring the data centers.

The devices 302, 304 and the data centers 332 can be capable of direct and indirect communication over the network 308. For example, using a network socket, the client computing device 304 can connect to a service operating in the data center 332 through an Internet protocol. The devices 302, 304 can set up listening sockets that may accept an initiating connection for sending and receiving information. The network 308 itself can include various configurations and protocols including the Internet, World Wide Web, intranets, virtual private networks, wide area networks, local networks, and private networks using communication protocols proprietary to one or more companies. The network 308 can support a variety of short- and long-range connections. The short- and long-range connections may be made over different bandwidths, such as 2.402 GHz to 2.480 GHz, commonly associated with the Bluetooth® standard, 2.4 GHz and 5 GHZ, commonly associated with the Wi-Fi® communication protocol; or with a variety of communication standards, such as the LTE® standard for wireless broadband communication. The network 308, in addition or alternatively, can also support wired connections between the devices 302, 304 and the data center 332, including over various types of Ethernet connection.

Although a single server computing device 302, client computing device 304, and data center 332 are shown in FIG. 3, it is understood that the aspects of the disclosure can be implemented according to a variety of different configurations and quantities of computing devices, including in paradigms for sequential or parallel processing, or over a distributed network of multiple devices. In some implementations, aspects of the disclosure can be performed on a single device connected to hardware accelerators configured for processing optimization models, and any combination thereof.

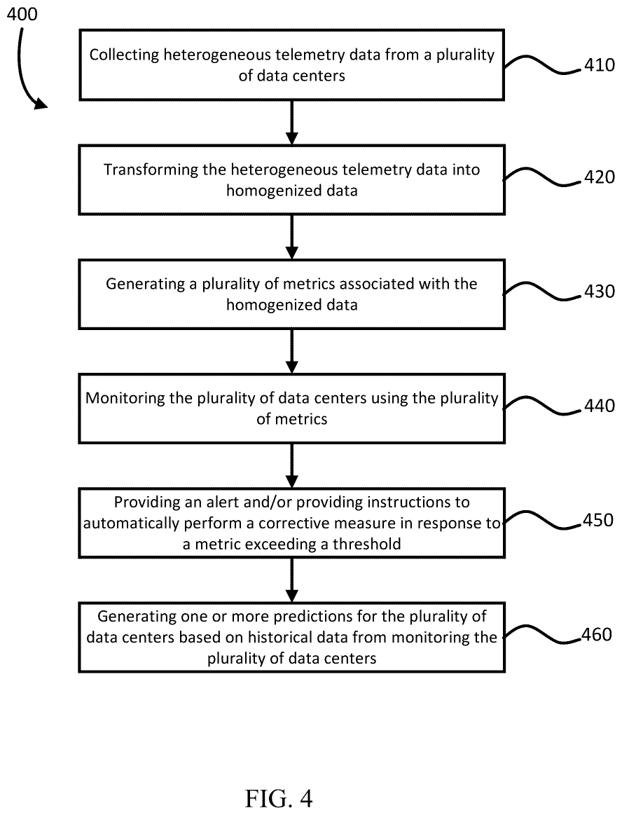

FIG. 4 depicts a flow diagram of an example process for managing various data centers. The example process 400 can be performed on a system of one or more processors in one or o more locations, such as the data center management system 100 as depicted in FIG. 1 or the data center management system 200 as depicted in FIG. 2.

As shown in block 410, the data center management system 100 can collect heterogeneous telemetry data from a plurality of data centers. The heterogeneous telemetry data can be received from a plurality of data sources associated with the plurality of data centers or from the plurality of data centers. The heterogeneous telemetry data can include telemetry data in a plurality of data formats, such as javascript object notation (JSON), comma separated value (CSV), protocol buffers, and/or text based format, as examples. The heterogeneous telemetry data can be associated with monitoring a fitness or health of each of the plurality of data centers, such as temperature, voltage, power, current, and/or pressure of various power and building equipment for the data centers 106.

As shown in block 420, the data center management system 100 can transform the heterogeneous telemetry data into homogenized data. The data center management system 100 can transform the heterogenous telemetry data using a mapping. The mapping can include key-value pairs for converting various data formats into a particular data format. The homogenized data can include telemetry data converted into a data object format with predetermined parameters for monitoring. The data center management system 100 can store the homogenized data in logs segregated by data center of the plurality of data centers. The logs can include one or more parameters for assessing the fitness or health of the data center.

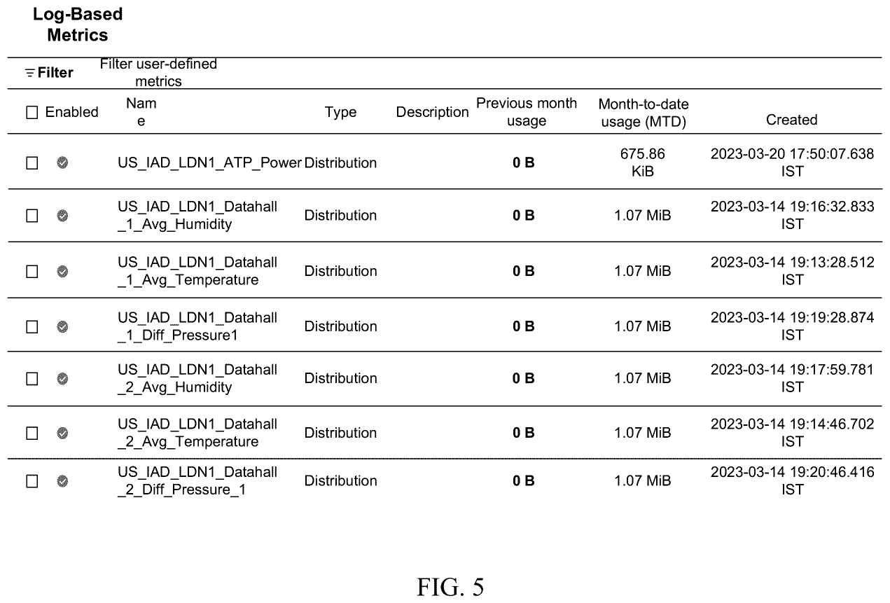

As shown in block 430, the data center management system 100 can generate a plurality of metrics associated with the homogenized data. The data center management system 100 can generate the metrics based on the one or more parameters for assessing the fitness or health of the data center, such as temperature or power. The data center management system 100 can generate the metrics using the logs that segregate the homogenized data by data center. The data center management system 100 can aggregate similar data points of the homogenized data together for the metrics. FIG. 5 depicts an example table showing various log-based metrics that can be generated.

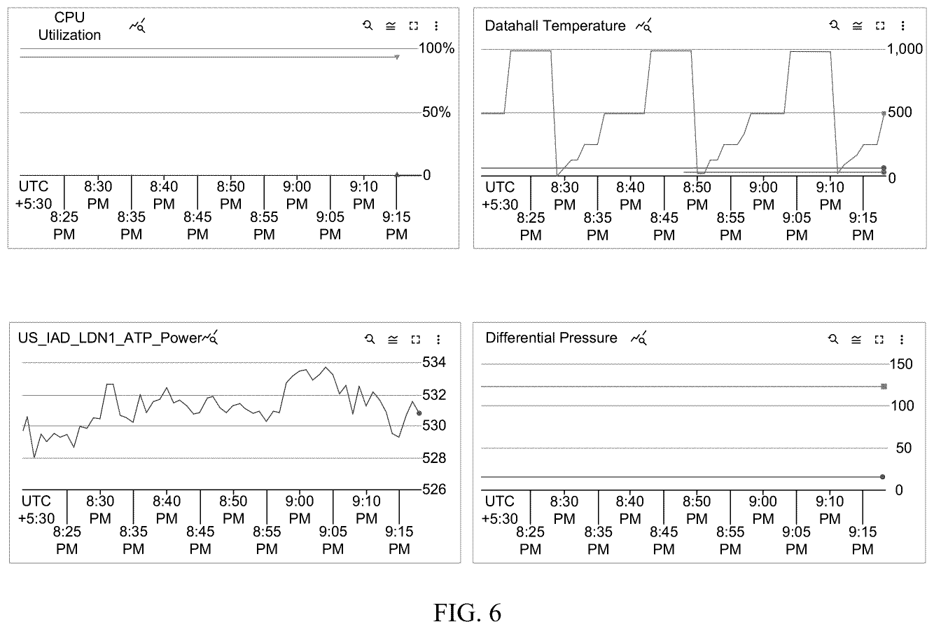

As shown in block 440, the data center management system 100 can monitor the plurality of data centers using the plurality of metrics. The data center management system 100 can display the plurality of metrics in real-time, such as via a client interface. FIG. 6 depicts an example dashboard showing real-time displays of various metrics. The data center management system 100 can compare the homogenized data of a log of a data center to data received by that data center to determine that the homogenized data of the log is within a threshold frequency range of data being received. For example, the data center management system 100 monitor temperature across the data centers as time series data to establish correlations in temperature over a timeline.

As shown in block 450, the data center management system 100 can provide an alert and/or provide instructions to automatically perform a corrective measure in response to a metric exceeding a threshold. The data center management system 100 can compare each of the plurality of metrics to one or more configurable thresholds. The data center management system 100 can determine at least one metric of the plurality of metrics has exceeded a threshold. The data center management system 100 can provide an alert or notification to a client device that the metric has exceeded the threshold and/or the data center management system 100 can provide instructions to a computing device associated with a data center whose metric exceeded the threshold to automatically perform a corrective measure, such as reducing processing rates or reverting a recently applied update to the data center.

As shown in block 460, the data center management system 100 can generate one or more predictions for the plurality of data centers based on historical data from monitoring the data centers using the metrics. The data center management system 100 can predict potential faults or issues in the data centers based on historical data of the metrics using one or more machine learning models.

Aspects of this disclosure can be implemented in digital electronic circuitry, in tangibly embodied computer software or firmware, and/or in computer hardware, such as the structure disclosed herein, their structural equivalents, or combinations thereof. Aspects of this disclosure can further be implemented as one or more computer programs, such as one or more modules of computer program instructions encoded on a tangible non-transitory computer storage medium for execution by, or to control the operation of, one or more data processing apparatus. The computer storage medium can be a machine-readable storage device, a machine-readable storage substrate, a random or serial access memory device, or combinations thereof. The computer program instructions can be encoded on an artificially generated propagated signal, such as a machine-generated electrical, optical, or electromagnetic signal, that is generated to encode information for transmission to suitable receiver apparatus for execution by a data processing apparatus.

The term “configured” is used herein in connection with systems and computer program components. For a system of one or more computers to be configured to perform particular operations or actions means that the system has installed on it software, firmware, hardware, or a combination thereof that cause the system to perform the operations or actions. For one or more computer programs to be configured to perform particular operations or actions means that the one or more programs include instructions that, when executed by one or more data processing apparatus, cause the apparatus to perform the operations or actions.

The term “computer program” refers to a program, software, a software application, an app, a module, a software module, a script, or code. The computer program can be written in any form of programming language, including compiled, interpreted, declarative, or procedural languages, or combinations thereof. The computer program can be deployed in any form, including as a standalone program or as a module, component, subroutine, or other unit suitable for use in a computing environment. The computer program can correspond to a file in a file system and can be stored in a portion of a file that holds other programs or data, such as one or more scripts stored in a markup language document, in a single file dedicated to the program in question, or in multiple coordinated files, such as files that store one or more modules, sub programs, or portions of code. The computer program can be executed on one computer or on multiple computers that are located at one site or distributed across multiple sites and interconnected by a data communication network.

The term “engine” refers to a software-based system, subsystem, or process that is programmed to perform one or more specific functions. The engine can be implemented as one or more software modules or components or can be installed on one or more computers in one or more locations. A particular engine can have one or more computers dedicated thereto, or multiple engines can be installed and running on the same computer or computers.

The processes and logic flows described herein can be performed by one or more computers executing one or more computer programs to perform functions by operating on input data and generating output data. The processes and logic flows can also be performed by special purpose logic circuitry, or by a combination of special purpose logic circuitry and one or more computers.

A computer or special purposes logic circuitry executing the one or more computer programs can include a central processing unit, including general or special purpose microprocessors, for performing or executing instructions and one or more memory devices for storing the instructions and data. The central processing unit can receive instructions and data from the one or more memory devices, such as read only memory, random access memory, or combinations thereof, and can perform or execute the instructions. The computer or special purpose logic circuitry can also include, or be operatively coupled to, one or more storage devices for storing data, such as magnetic, magneto optical disks, or optical disks, for receiving data from or transferring data to. The computer or special purpose logic circuitry can be embedded in another device, such as a mobile phone, a personal digital assistant (PDA), a mobile audio or video player, a game console, a Global Positioning System (GPS), or a portable storage device, e.g., a universal serial bus (USB) flash drive, as examples.

Computer readable media suitable for storing the one or more computer programs can include any form of volatile or non-volatile memory, media, or memory devices. Examples include semiconductor memory devices, e.g., EPROM, EEPROM, or flash memory devices, magnetic disks, e.g., internal hard disks or removable disks, magneto optical disks, CD-ROM disks, DVD-ROM disks, or combinations thereof.

Aspects of the disclosure can be implemented in a computing system that includes a back end component, e.g., as a data server, a middleware component, e.g., an application server, or a front end component, e.g., a client computer having a graphical user interface, a web browser, or an app, or any combination thereof. The components of the system can be interconnected by any form or medium of digital data communication, such as a communication network. Examples of communication networks include a local area network (LAN) and a wide area network (WAN), e.g., the Internet.

The computing system can include clients and servers. A client and server can be remote from each other and interact through a communication network. The relationship of client and server arises by virtue of the computer programs running on the respective computers and having a client-server relationship to each other. For example, a server can transmits data, e.g., an HTML page, to a client device, e.g., for purposes of displaying data to and receiving user input from a user interacting with the client device. Data generated at the client device, e.g., a result of the user interaction, can be received at the server from the client device.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A method for managing various data centers comprising:
collecting, by one or more processors, heterogeneous telemetry data from a plurality of data centers;
transforming, by the one or more processors, the heterogenous telemetry data into homogenized data using a mapping;
generating, by the one or more processors, a plurality of metrics associated with the homogenized data; and
monitoring, by the one or more processors, the plurality of data centers using the plurality of metrics.

2. The method of claim 1, further comprising displaying, by the one or more processors, the plurality of metrics in real-time via a user interface.

3. The method of claim 1, wherein the heterogenous telemetry data is collected from a plurality of data sources associated with the plurality of data centers.

4. The method of claim 1, wherein the heterogenous telemetry data comprises telemetry data in a plurality of data formats.

5. The method of claim 1, wherein the homogenized data comprises telemetry data converted to a data object format with predetermined parameters for monitoring.

6. The method of claim 1, further comprising storing, by the one or more processors, the homogenized data in logs segregated by data center of the plurality of data centers.

7. The method of claim 6, further comprising determining, by the one or more processors, that the homogenized data of a log of a data center is being received within a threshold frequency range.

8. The method of claim 1, further comprising comparing the plurality of metrics to one or more configurable thresholds.

9. The method of claim 8, further comprising:
determining, by the one or more processors, at least one metric of the plurality of metrics has exceeded a threshold; and
providing, by the one or more processors, a notification to a client device in response to the at least one metric exceeding the threshold.

10. The method of claim 8, further comprising:
determining, by the one or more processors, at least one metric of the plurality of metrics has exceeded a threshold; and
providing, by the one or more processors, instructions to a computing device associated with a data center of the plurality of data centers to automatically perform a corrective measure in response to the at least one metric exceeding the threshold.

11. The method of claim 1, further comprising generating, by the one or more processors, a prediction associated with a data center based on historical data of the plurality of metrics.

12. A system comprising:
one or more processors; and
one or more storage devices coupled to the one or more processors and storing instructions that, when executed by the one or more processors, cause the one or more processors to perform operations for managing various data centers, the operations comprising:
collecting heterogeneous telemetry data from a plurality of data centers;
transforming the heterogenous telemetry data into homogenized data using a mapping;
generating a plurality of metrics associated with the homogenized data; and
monitoring the plurality of data centers using the plurality of metrics.

13. The system of claim 12, wherein the operations further comprise displaying the plurality of metrics in real-time via a user interface.

14. The system of claim 12, wherein the heterogenous telemetry data comprises telemetry data in a plurality of data formats.

15. The system of claim 12, wherein the homogenized data comprises telemetry data converted to a data object format with predetermined parameters for monitoring.

16. The system of claim 12, wherein the operations further comprise storing the homogenized data in logs segregated by data center of the plurality of data centers.

17. The system of claim 16, wherein the operations further comprise determining that the homogenized data of a log of a data center is being received within a threshold frequency range.

18. The system of claim 12, wherein the operations further comprise:
comparing the plurality of metrics to one or more configurable thresholds;
determining at least one metric of the plurality of metrics has exceeded a threshold; and
providing a notification to a client device in response to the at least one metric exceeding the threshold.

19. The system of claim 12, wherein the operations further comprise:
comparing the plurality of metrics to one or more configurable thresholds;
determining at least one metric of the plurality of metrics has exceeded a threshold; and
providing instructions to a computing device associated with a data center of the plurality of data centers to automatically perform a corrective measure in response to the at least one metric exceeding the threshold.

20. A non-transitory computer readable medium for storing instructions that, when executed by one or more processors, cause the one or more processors to perform operations for managing various data centers, the operations comprising:
collecting heterogeneous telemetry data from a plurality of data centers;
transforming the heterogenous telemetry data into homogenized data using a mapping;
generating a plurality of metrics associated with the homogenized data; and
monitoring the plurality of data centers using the plurality of metrics.
